(19) United States
(12) Patent Application Publication
(10) Pub. No.: US 2017/0205736 A1
(43) Pub. Date: Jul. 20, 2017

(54) FIXING MEMBER AND METHOD FOR PRODUCING SAME

(71) Applicant: SYNZTEC CO., LTD., Tokyo (JP)

(72) Inventors: Takeyoshi TEDORI, Kanagawa (JP); Yuji SUGIYAMA, Kanagawa (JP)

(21) Appl. No.: 15/405,826

(22) Filed: Jan. 13, 2017

(30) Foreign Application Priority Data
Jan. 14, 2016 (JP) 2016-005534

(51) Int. Cl. G03G 15/20; B29C 44/12; B29C 44/56

(52) U.S. Cl. CPC G03G 15/206; B29C 44/56; B29C 44/1266; B29K 2083/00

(57) ABSTRACT

A fixing member which ensures a surface pressure during toner fixation and which can achieve both an enhanced grip force of an elastic layer and cost efficiency; and a method for producing the fixing member are provided. The fixing member, as a press roll, has the elastic layer of a foamed elastic material on the outer peripheral surface of a core body. The elastic layer is an integrally shaped product of the foamed elastic material. When the specific gravity of the foamed elastic material in axially opposite end portions (grip portions) of the elastic layer is designated as d₁, the specific gravity of the foamed elastic material in a portion (free portion) of the elastic layer other than the grip portions is designated as d₂, and the specific gravity d₂ is 0.7 or less, the proportion of the difference between d₁ and d₂ to the specific gravity d₂ is 10-70%.

The entire disclosure of Japanese Patent Application No. 2016-005534 filed on Jan. 14, 2016 is expressly incorporated by reference herein.

### TECHNICAL FIELD

This invention relates to a fixing member, particularly, for use in a fixing unit of an image forming apparatus such as an electrophotographic copier or printer; and a method for producing the fixing member.

### BACKGROUND ART

In a fixing unit (fixing device) of an image forming apparatus such as an electrophotographic copier or printer, use is made of a fixing belt composed of an electrocast material (Ni (nickel), Ni/Cu(copper)/Ni, PI (polyimide resin), SUS (stainless steel) or the like), an elastic layer (foamed silicone rubber), and a mold release layer (fluororesin tube); and a fixing roll, a press roll, etc. composed of a core body, an elastic layer, and a mold release layer. In such a fixing system of the image forming apparatus, the belt fixing mode is predominant and, in particular, a grip force (frictional force) for driving the fixing belt is a property required of the press roll. To enhance the grip force, a method of increasing the coefficient of friction at both ends of the press roll is known.

A press roll 100 shown in FIG. 1 is composed of a core body 101, an elastic layer 102, and a mold release layer 103. A foamed silicone rubber layer (also called “silicone sponge layer”) 104 constituting the elastic layer 102 is provided on the outer peripheral surface of the core body 101, and a fluororesin tube 105 constituting the mold release layer 103 is provided on the outer peripheral surface of the foamed silicone rubber layer 104. In the press roll 100, the fluororesin tube 105 covering its axially opposite end portions (hereinafter referred to as “grip portions 106, 107”) is peeled off to expose the foamed silicone rubber layer 104 (see, for example, Patent Documents 1, 2). This is common practice as a method for enhancing the grip force (increasing the coefficient of friction) of the press roll 100.

Other methods conceivable for this purpose include (1) a method of pressing a different material into the grip portions 106, 107 of the press roll 100 (see, for example, Patent Document 3); (2) a method of raising the surface pressure of the press roll 100 by increasing its hardness; and (3) a method of coating the grip portions 106, 107 with a paint having a high coefficient of friction. With the method (1), however, the need to mold the press roll 100 and the grip portions 106, 107 separately and assemble them poses the problem of a cost increase. The method (2) needs to increase the hardness of the press roll 100 as a whole, thus involving the problem that a surface pressure necessary for the fixation of a toner is not obtained. Furthermore, the method (3) necessitates the selection, coating and drying of the paint, causing to arise a cost problem, like the method (1).

### PRIOR ART DOCUMENTS

### Patent Documents

[Patent Document 1] JP-A-2015-075659

[Patent Document 2] JP-A-7-168471

[Patent Document 3] JP-A-2012-145710

### SUMMARY OF THE INVENTION

### Problems to be Solved by the Invention

The present invention has been proposed in the light of the above-described problems with the conventional technologies. It is an object of this invention to provide a fixing member which ensures a surface pressure during toner fixation and which can achieve both an enhanced grip force of the elastic layer and cost efficiency; and a method for producing the fixing member.

### Means for Solving the Problems

An aspect of the present invention for solving the above problems is a fixing member having an elastic layer of a foamed elastic material on an outer peripheral surface of a core body, wherein the elastic layer is an integrally shaped product of the foamed elastic material and, when the specific gravity of the foamed elastic material in axially opposite end portions of the elastic layer is designated as d₁, the specific gravity of the foamed elastic material in a portion of the elastic layer other than the axially opposite end portions is designated as d₂, and the specific gravity d₂ is 0.7 or less, the proportion of the difference between the specific gravity d₁ and the specific gravity d₂ to the specific gravity d₂ is 10% or more, but 70% or less.

In the fixing member according to the above aspect, a mold release layer composed of a fluororesin tube may be present on an outer peripheral surface of the portion of the elastic layer other than the axially opposite end portions.

Another aspect of the present invention for solving the above problems is a method for producing a fixing member having an elastic layer of a foamed elastic material on an outer peripheral surface of a core body, comprising: a shaping step of extruding a foamable material onto the outer peripheral surface of the core body; a foaming step of foaming the foamable material, which has been extruded in the shaping step, while restricting foaming of opposite end portions of the extruded foamable material as compared with a portion thereof other than the opposite end portions, to obtain the foamed elastic material; and a polishing step of polishing the foamed elastic material obtained in the foaming step, thereby forming the elastic layer, wherein the elastic layer is an integrally shaped product of the foamed elastic material and, when the specific gravity of the foamed elastic material in axially opposite end portions of the elastic layer is designated as d₁, the specific gravity of the foamed elastic material in a portion of the elastic layer other than the axially opposite end portions is designated as d₂, and the specific gravity d₂ is 0.7 or less, the proportion of the difference between the specific gravity d₁ and the specific gravity d₂ to the specific gravity d₂ is 10% or more, but 70% or less.

In the method for producing a fixing member according to the above aspect, in the foaming step, the foamable material extruded in the shaping step may be foamed, with a foaming restriction member being mounted on each of the opposite end portions of the foamable material.

Alternatively, in the method for producing a fixing member according to the above aspect, in the foaming step, the foamable material extruded in the shaping step may be foamed, with a foaming restriction member being mounted on the foamable material.

### Effects of the Invention

According to the present invention, it is possible to obtain a fixing member which can ensure a surface pressure necessary for toner fixation and which can achieve both an enhanced grip force of the elastic layer and cost efficiency.

### BRIEF DESCRIPTION OF THE DRAWINGS

FIG. 1 is a schematic view of a conventional fixing member.

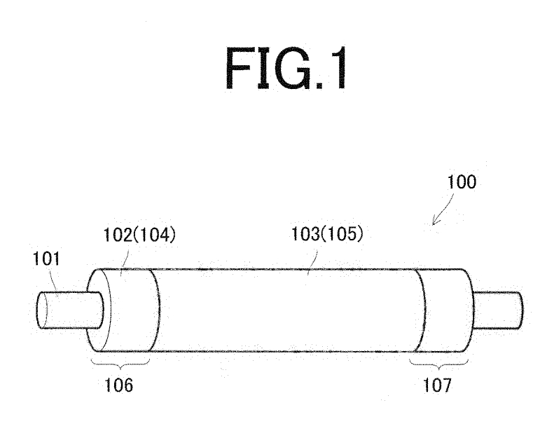

FIG. 2 is a schematic view of a fixing member according to Embodiment 1.

FIGS. 3A to 3C are views showing an example of a manufacturing process for constituent elements of the fixing member according to Embodiment 1.

FIG. 4 is a schematic sectional view of a foaming restriction member according to Embodiment 1.

FIG. 5 is a schematic view showing a configuration example of a fixing device according to Embodiment 1.

FIG. 6 is a schematic sectional view of a foaming restriction member according to Embodiment 2.

FIG. 7 is a schematic view of a fixing member according to Embodiment 2.

FIG. 8 is a schematic sectional view of a foaming restriction member according to Embodiment 3.

FIG. 9 is a view showing the results of measurement of the outer diameter of each of rolls of Example 1 and Comparative Example 1.

FIG. 10 is a view showing the results of measurement of the surface pressure of each of the rolls of Example 1 and Comparative Example 1.

### MODE FOR CARRYING OUT THE INVENTION

The present invention will now be described in detail based on its respective embodiments. The following descriptions illustrate an aspect of the invention, and the invention can be changed or modified arbitrarily without deviating from its scope and spirit.

### Embodiment 1

### 1. Press Roll and Method for its Production

A fixing member according to the present invention is preferably used in a fixing unit (fixing device) of an image forming apparatus such as an electrophotographic copier or printer and, in such a fixing device, is used to fix an unfixed toner image on a recording medium, such as paper, by heat and pressure. In Embodiment 1, a press roll is illustrated as the fixing member.

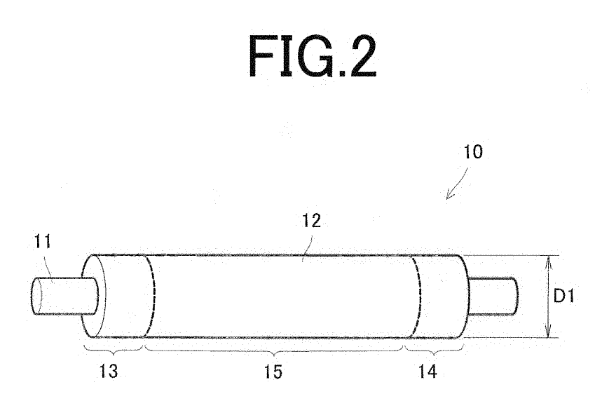

FIG. 2 is a schematic view of the fixing member according to Embodiment 1. As shown in the drawing, a press roll 10 which is the fixing member includes a core body 11, and an elastic layer 12 formed on the outer peripheral surface of the core body 11. The elastic layer 12 in the press roll 10 is a shaped product formed by continuously integrally shaping axially opposite end portions (these portions will hereinafter be referred to as “grip portions 13, 14”) and a portion other than the grip portions 13, 14 (this portion will hereinafter be referred to as a “free portion 15”) (this shaped product may be called an “integrally shaped product”).

The core body 11 is composed of a metallic or resinous material excellent in heat conductivity and mechanical strength. There is no limitation on the material for the core body 11 and, for example, a metallic material such as an SUS alloy, nickel (Ni), a nickel alloy, iron (Fe), magnetic stainless steel, or a cobalt-nickel (Co—Ni) alloy; or a resinous material such as PI (polyimide resin) can be used. Nor is there any particular limitation on the shape of the core body 11, and the core body 11 may be hollow or nonhollow. In the present embodiment, a core metal is used as the core body 11.

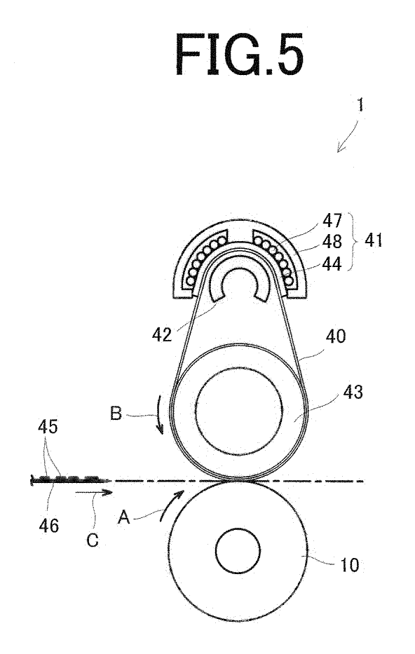

The elastic layer 12 is provided on the outer peripheral surface of the core body 11 via an adhesive layer (not shown). The elastic layer 12 is not particularly limited, if it comprises a foamed elastic material having low heat capacity and low thermal conductivity. As the elastic layer 12, there can be used a product formed by shaping a foamable material, which has an additive, such as a chemical foaming agent, finely dispersed in a publicly known elastomer or rubber, into a foamed form (foam) or a porous form. Examples of the elastomer or rubber used in the preparation of the foamed elastic material include silicone rubber, fluororubber, and urethane rubber. The foamed elastic material constituting the elastic layer 12 can be shaped in a form, for example, of a straight type, a crown type (a type in which the outer diameter of the free portion 15 is larger than the outer diameter of the grip portions 13, 14), or an inverse crown type (a type in which the outer diameter of the free portion 15 is smaller than the outer diameter of the grip portions 13, 14), and any such form can be applied. The outer diameter D1 of the elastic layer 12 can be changed, as appropriate, according to a fixing device 1 to be applied (see FIG. 5). In the present embodiment, the straight type elastic layer 12 composed of silicone rubber whose grip portions 13, 14 have the outer diameter D1 of 34.0 mm is used.

The foamed elastic material constituting the elastic layer 12 is formed such that the foaming ratio of the grip portions 13, 14 and the foaming ratio of the free portion 15 are different from each other. That is, in foaming the above-mentioned elastomer or rubber, the foaming of the grip portions 13, 14 is restricted, whereas the free portion 15 is foamed freely. By so doing, the foaming ratio of the free portion 15 becomes higher than the foaming ratio of the grip portions 13, 14, with the result that the foamed elastic material with different foaming ratios in the axial direction is formed. In the present embodiment, the elastic layer 12 is formed using such a foamed elastic material. Thus, the specific gravity, hardness, etc. of the grip portions 13, 14 are different from those of the free portion 15. The difference between the specific gravity of the grip portions 13, 14 and the specific gravity of the free portion 15 in the elastic layer 12 is preferably 0.02 or more, further preferably 0.05 or more, but 0.2 or less. That is, with the present embodiment, when the specific gravity of the free portion 15 is 0.7 or less, preferably 0.3 or more, but 0.7 or less, the proportion of the difference between the specific gravity of the grip portions 13, 14 and the specific gravity of the free portion 15 to the specific gravity of the free portion 15 is 10% or more, but 70% or less, preferably 10% or more, but 50% or less, more preferably 20% or more, but 50% or less, most preferably 30% or more, but 50% or less. The difference between the hardness of the grip portions 13, 14 and the hardness of the free portion 15 (compliance standards: JIS K 7312, JIS S 6050) is preferably 3° or more, but 10° or less, from the viewpoint of ensuring durability comparable to that of the conventional fixing member.

If, when the specific gravity of the free portion 15 of the elastic layer 12 is within a predetermined range, the proportion of the difference in specific gravity between the grip portions 13, 14 and the free portion 15 to the specific gravity of the free portion 15 is within the above-described range, the grip force (frictional force) with which the press roll 10 drives a heat generating sleeve 40 (belt-shaped) can be increased, and the surface pressure during toner fixation can be ensured, in the fixing device 1 (see FIG. 5) to be described later. Upon rotational driving of the press roll 10, moreover, a fixing roll 43 can be smoothly driven and rotated, with the heat generating sleeve 40 being held between the press roll 10 and the fixing roll 43.

In the present embodiment, a tube or a coating layer (mold release layer) comprising fluororesin, silicone rubber or the like may be provided, if necessary, via an adhesive layer on the outer peripheral surface of the free portion 15 of the elastic layer 12. For example, a tetrafluoroethylene/perfluoroalkyl vinyl ether copolymer (PFA resin) with excellent heat resistance is preferably used as the fluororesin constituting the fluororesin tube. Examples of the fluororesin other than PFA resin, which constitutes the fluororesin tube, include a tetrafluoroethylene/hexafluoropropylene copolymer (FEP), polytetrafluoroethylene (PTFE), and an ethylene/tetrafluoroethylene copolymer (ETFE). Also included are polychlorotrifluoroethylene (PCTFE), an ethylene/chlorotrifluoroethylene copolymer (ECTFE), and polyvinylidene fluoride (PVDF). Alternatively, any one of these fluororesins can be used alone, or a plurality of these fluororesins can be combined and used.

The adhesive layer provided during formation of the elastic layer 12 or the mold release layer is composed of a cured product of an addition curable silicone rubber adhesive. The addition curable silicone rubber adhesive includes an addition curable silicone rubber incorporating a self-adhering component. Concretely, the addition curable silicone rubber adhesive contains an organopolysiloxane having an unsaturated hydrocarbon group typified by a vinyl group, a hydrogen organopolysiloxane, and a platinum compound as a crosslinking catalyst, and is cured by an addition reaction. As such an adhesive, publicly known ones can be used.

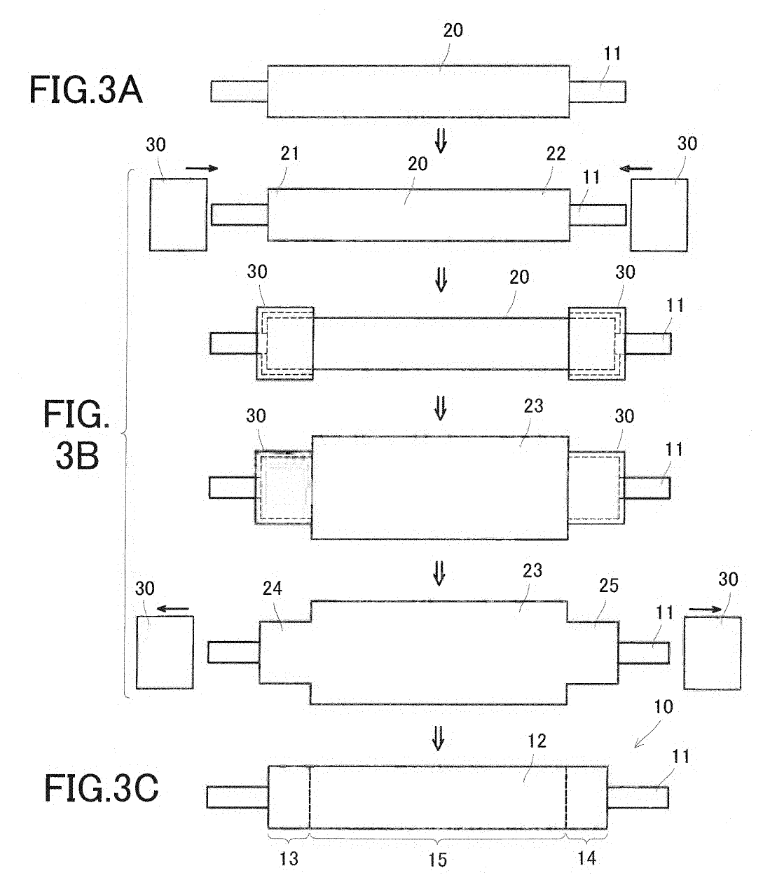

Next, a method for producing the press roll 10 will be described. The method for producing the press roll 10 is characterized by a step of forming the elastic layer 12. For other steps, publicly known manufacturing methods, for example, the methods described in JP-A-2011-026617 and JP-A-2013-231875, can be applied. Here, therefore, the step of forming the elastic layer 12 will be described by reference to FIGS. 3A to 3C, and descriptions of the other steps will be omitted as appropriate.

FIGS. 3A to 3C are views showing an example of the manufacturing process for the constituent elements of the fixing member according to Embodiment 1. As shown in these drawings, the process for forming the elastic layer 12 comprises: a shaping step (a) of extruding a foamable material 20; a foaming step (b) of foaming the extruded foamable material 20; and a polishing step (c) of polishing the foamed foamable material 20 (foamed elastic material 23) to form the elastic layer 12.

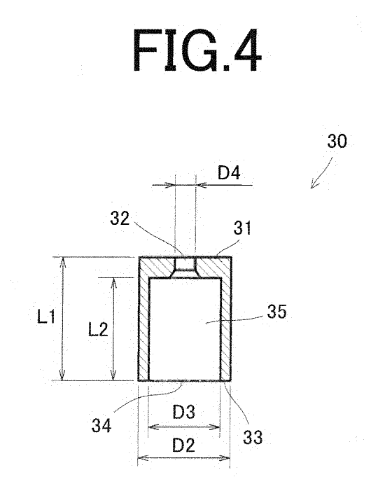

In the foaming step (b), a foaming restriction member (flange 30 to be described later) is used. FIG. 4 is a schematic view of the foaming restriction member according to Embodiment 1. As shown in FIG. 4, the flange 30 has an insertion portion 32 formed in an upper surface 31 thereof for inserting through it the end of the core body 11, and has an opening 34 formed in a bottom surface 33 thereof. Inside the flange 30, a mounting portion 35 is provided concavely which is mounted on one of opposite end portions 21, 22 of the foamable material 20 extruded onto the core body 11 in the shaping step (a).

The size of the flange 30 can be changed, as appropriate, according to the difference in specific gravity between the grip portions 13, 14 and the free portion 15 of the elastic layer 12 to be formed; the size of the core body 11; or the type of the image forming apparatus to be applied. In the present embodiment, there is used the flange 30 whose outer diameter D2 is 40 mm, whose inner diameter D3 (inner diameter of mounting portion 35) is 34 mm, in which the bore diameter D4 of the insertion portion 32 is 10 mm, whose axial length L1 is 47.4 mm, and in which the axial length L2 of the mounting portion 35 is 42.4 mm.

In the shaping step (a), additives such as a chemical foaming agent, a vulcanizing agent, a catalyst, and a coloring agent are blended with an elastomer or rubber to prepare the foamable material 20. Then, the core body 11 is provided, and the foamable material 20 is extruded onto the outer peripheral surface of the core body 11 with the use of an extruder (not shown) so as to have an outer diameter of 30.4 mm.

The chemical foaming agent is not particularly limited, but for example, 1,1′-azobis(cyclohexane-1-methylcarboxylate) can be used. The amount of the chemical foaming agent blended is not particularly limited, but for example, 3 to 8 parts by mass of the chemical foaming agent may be blended with 100 parts by mass of the elastomer or rubber. The types and the amounts added of the additives such as the vulcanizing agent, catalyst and coloring agent can be selected, as appropriate, according to the elastomer or rubber and the chemical foaming agent used.

Then, in the foaming step (b), the flange 30 (foaming restriction member) is mounted on each of the opposite end portions 21, 22 of the foamable material 20 extruded in the shaping step (a). Then, the foamable material 20 in the opposite end portions 21, 22 is foamed while being restricted by the flanges 30, whereas the foamable material 20 in a portion other than the opposite end portions 21, 22 is foamed freely, and the foamable materials 20 in both states are allowed to stand for a predetermined period of time. As a result, the foamed elastic material 23 is obtained in which the foaming ratio of the foamable materials 20 in the opposite end portions 21, 22 is restricted, whereby the foamed materials 20 located there are each formed into the shape of the flange 30. Then, the flanges 30 are detached from opposite end portions 24, 25 of the resulting foamed elastic material 23.

In the foaming step (b), as described above, the foamable material 20 extruded onto the core body 11 in the shaping step (a) is foamed, with its opposite end portions 21, 22 being mounted with the flanges 30, to obtain the foamed elastic material 23. That is, the portions of the foamed elastic material 23 mounted with the flanges 30 are finally turned into the grip portions 13, 14 of the elastic layer 12 at the foaming ratio restricted as a consequence of the moderate restriction of the foaming of the foamable material 20. On the other hand, the portion of the foamed elastic material 23 not mounted with the flange 30 is finally turned into the free portion 15 of the elastic layer 12 as a consequence of the free foaming of the foamable material 20. Since the foaming ratio of the grip portions 13, 14 is lower than the foaming ratio of the free portion 15 of the elastic layer 12, the specific gravity and hardness of the grip portions 13, 14 are greater than those of the free portion 15.

Then, in the polishing step (c), the opposite end portions 24, 25 of the foamed elastic material 23 obtained in the foaming step (b) are each cut to a predetermined length by a cutting mechanism. Then, the cut surfaces and the surface of the foamed elastic material 23 are polished by a polishing mechanism to form the elastic layer 12. By this procedure, there is obtained the press roll 10 formed with the straight type elastic layer 12 which is composed of the grip portions 13, 14 and the free portion 15 and in which the outer diameters of the grip portions 13, 14 and the free portion 15 are the same.

In the press roll 10 obtained by the above steps (a) to (c), the difference between the specific gravity of the grip portions 13, 14 and the specific gravity of the free portion 15 of the elastic layer 12 can be rendered 0.02 or more simply by use of the flanges 30 during the formation of the elastic layer 12. Furthermore, the elastic layer 12 is obtained as an integrally shaped product by continuous integral shaping, because the foamable material 20 extruded on the core body 11 is foamed, with its opposite end portions 21, 22 being mounted with the flanges 30. That is, the grip portions 13, 14 and the free portion 15 of the elastic layer 12 are composed of the same material, so that no costs are incurred, for example, for forming the grip portions 13, 14 from a material different from the material for the free portion 15. Thus, the method adopted herein can provide the press roll 10 which is excellent in the cost aspect as well, which can ensure a surface pressure during toner fixation, and which can achieve both of an increase in the grip force of the elastic layer 12 and cost efficiency.

If a tube or coating layer (mold release layer) comprising fluororesin, silicone rubber or the like is provided via an adhesive layer on the outer peripheral surface of the press roll 10 obtained by the steps (a) to (c), a step of forming the mold release layer may be added after the polishing step (c). In this additional step, it is advisable to form the mold release layer on the outer peripheral surface of the free portion 15 of the press roll 10 by applying a publicly known method (see, for example, Patent Document 2).

In the present embodiment, moreover, in order to further cure the foamed elastic material 23 obtained in the foaming step (b), a step of curing the foamed elastic material 23 may be added between the foaming step (b) and the polishing step (c). In this step, the foamed elastic material 23 is cured under conditions conformed to the foamable material 20. If required, after precuring is performed in the foaming step (b), this step may be performed for main curing.

### 2. Fixing Device

Next, a fixing device according to the present embodiment will be described. The fixing device is installed on an image forming apparatus to fix an unfixed toner image on a recording medium by heat and pressure.

FIG. 5 is a schematic sectional view showing a configuration example of the fixing device according to Embodiment 1. As shown in FIG. 5, a fixing device 1 comprises a heat generating sleeve 40 as a heat generating rotor, an electromagnetic induction heating device 41 (heating means) as a magnetic field generation means, a magnetic field absorption member 42 as a magnetic field absorbing means for absorbing a magnetic field generated by the electromagnetic induction heating device 41, and a fixing roll 43 and the press roll 10 as a pair of pressurizing members for rotating the heat generating sleeve 40 while holding it therebetween.

The heat generating sleeve 40 is looped over the fixing roll 43 so that its upper part is curved arcuately along a coil guide 44 to be described later. By so curving the upper part of the heat generating sleeve 40 arcuately along the coil guide 44, the traveling properties of the heat generating sleeve 40 can be stabilized.

The fixing roll 43 is rotatably journaled on the upper side of the fixing device 1, while the press roll 10 is rotatably journaled on the lower side of the fixing device 1. The press roll 10 is rotationally driven in the direction of an arrow A by a drive source (not shown). Upon the rotation of the press roll 10, the fixing roll 43 rotates in a following manner while holding the heat generating sleeve 40 between it and the press roll 10. Thus, the heat generating sleeve 40 is rotated in the direction of an arrow B while being held between the fixing roll 43 and the press roll 10. Because of the heat generating sleeve 40 being held and rotated, a nip portion (not shown) for heat-fixing an unfixed toner image 45 on a recording medium 46 is formed between the heat generating sleeve 40 and the press roll 10.

The electromagnetic induction heating device 41 comprises a magnetic field generation means of an electromagnetic induction heating (IH: induction heating) mode, and is equipped with an excitation coil 47 disposed along the outer peripheral surface of an arcuately curved site of the coil guide 44 on the heat generating sleeve 40; and a core 48 covering the excitation coil 47 and composed of ferrite. The excitation coil 47 is formed using a litz wire consisting of strands woven together, and the electromagnetic induction heating device 41 is formed to have a semicircular cross-sectional shape so as to cover the outer peripheral surface of the heat generating sleeve 40.

The magnetic field absorption member 42 is disposed at a site opposed to the excitation coil 47 across the heat generating sleeve 40, and absorbs a magnetic field generated by the electromagnetic induction heating device 41.

An excitation current of a predetermined frequency (e.g., of the order of 20 to 60 kHz) is applied from an excitation circuit (not shown) to the excitation coil 47 of the electromagnetic induction heating device 41. As a result, an alternating current magnetic field is generated between the core 48 and the magnetic field absorption member 42, whereby an eddy current is generated on the surface of the heat generating sleeve 40 to cause heat generation to the heat generating sleeve 40.

The core 48 is provided in the center of, and a part of the back of, the excitation coil 47 aligned. A high permeability material, such as permalloy, can be used aside from ferrite, as the material for the core 48 and the magnetic field absorption member 42.

The fixing device 1 transports the recording medium 46, to which the unfixed toner image 45 has been transferred, in the direction of an arrow C so as to bring its surface bearing the unfixed toner image 45 into contact with the heat generating sleeve 40, whereby the unfixed toner image 45 can be heat-fixed on the recording medium 46.

Besides, the fixing device 1 uses the press roll 10 provided with the elastic layer 12 increased in the specific gravity of the aforementioned grip portions 13, 14 (see FIG. 2). Thus, the grip force of the press roll 10 for driving the heat generating sleeve 40 can be enhanced, and the fixability of the unfixed toner image 45 onto the recording medium 46 can be increased to ensure the high quality of the image. Moreover, the press roll 10 having the above-mentioned excellent properties can be prepared by a simple method, and the cost incurred for the image forming apparatus can be reduced.

### Embodiment 2

A fixing member according to Embodiment 2 is different from that of Embodiment 1 in the shape of its opposite end portions. In Embodiment 2, therefore, only the differences from Embodiment 1 will be described, and explanations for other parts will be omitted as appropriate.

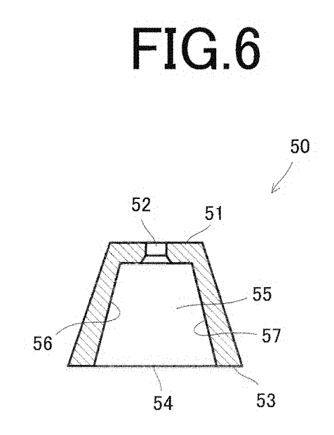

FIG. 6 is a schematic view of a foaming restriction member according to Embodiment 2. In the present embodiment, a tapered flange 50 as shown in FIG. 6 is used as a foaming restriction member different from the foaming restriction member (flange 30) of Embodiment 1. The tapered flange 50, like the flange 30, has an insertion portion 52 formed in an upper surface 51 thereof for inserting through it the end of the core body 11 (see FIG. 2), and has an opening 54 formed in a bottom surface 53 thereof. Inside the tapered flange 50, as in Embodiment 1, a mounting portion 55 is provided concavely which is mounted on one of the opposite end portions 21, 22 of the foamable material 20 (see FIG. 3B extruded onto the core body 11 in the shaping step (a).

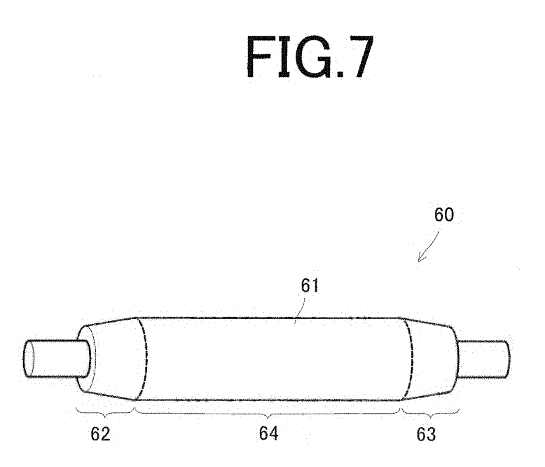

The tapered flange 50 has a tapered structure tapering off from the bottom surface 53 toward the upper surface 51, and thus the mounting portion 55 also has a similar structure. That is, when the tapered flange 50 is applied instead of the flange 30 in the step of forming the elastic layer 12 shown in FIGS. 3A to 3C, an elastic layer 61 (see FIG. 7) having a tapered structure in which its opposite end portions tapering off toward the axially opposite leading ends is obtained, as will be described in detail later.

When, in the foaming step (b) shown in FIGS. 3A to 3C, the tapered flange 50 is mounted on each of the opposite end portions 21, 22 of the foamable material 20 obtained in the shaping step (a), the foamable materials 20 in the opposite end portions 21, 22 are restricted in foaming by the tapered flanges 50. The restriction of the foaming becomes stronger toward the axially opposite leading ends, so that the foaming ratio changes to smaller values toward the axially opposite leading ends. In the present embodiment, the foaming ratio of the foamable material 20 is progressively decreased, whereby the density changes according to the inclination of the opposite side walls 56, 57 of the mounting portion 55. As a result, a foamed elastic material formed in the shape of the tapered flange 50 (not shown) is obtained. Then, as in Embodiment 1, the polishing step (c) is performed to obtain a press roll 60 (see FIG. 7) to be described later.

FIG. 7 is a schematic view of the fixing member according to Embodiment 2. As shown in FIG. 7, the press roll 60 has the same configuration as that of the press roll 10 of Embodiment 1, except that the elastic layer 61 has a tapered structure in which its grip portions 62, 63 taper off toward the axially opposite leading ends. This shape of the grip portions 62, 63 corresponds to the shape of the mounting portion 55 of the tapered flange 50 as described above. That is, the foaming ratio in the grip portions 62, 63 gradually becomes lower toward the axially opposite leading ends, and the specific gravity and hardness of the grip portions 62, 63 gradually become greater toward the leading ends.

In the present embodiment, therefore, at least the difference between the specific gravity in the neighborhood of the axially opposite leading ends of the grip portions 62, 63 and the specific gravity of a free portion 64 of the elastic layer 61 is 0.02 or more; when the specific gravity of the free portion 64 is 0.7 or less, the proportion of the difference between the specific gravity in the neighborhood of the axially opposite leading ends of the grip portions 62, 63 and the specific gravity of the free portion 64 to the specific gravity of the free portion 64 is 10% or more, but 70% or less; and further the difference between the hardness in the neighborhood of the axially opposite leading ends of the grip portions 62, 63 and the hardness of the free portion 64 is 3° or more, but 10° or less. Hence, when the press roll 60 is applied to the fixing device 1 (see FIG. 5), as in Embodiment 1, the grip force for driving the heat generating sleeve 40 (belt-shaped) can be enhanced, and the surface pressure during toner fixation can be ensured.

In the present embodiment, moreover, the specific gravity and hardness distributions of the press roll can be easily controlled by using the tapered flange 50 with the inner diameter gradually decreased from the side of the bottom surface 53 toward the upper surface 51, namely, the foaming restriction member of the shape conformed to the portions requiring increases in the specific gravity and hardness (in the case of the present embodiment, portions near the leading ends of the grip portions 62, 63). Also, according to the present embodiment, the specific gravity and hardness distributions of the press roll can be controlled, without the introduction of new facilities or without an increase in the number of steps. Thus, a press roll excellent in cost efficiency and a method for its production can be provided.

### Embodiment 3

A fixing member according to Embodiment 3 is a member having a foaming section and a foaming restriction section. In Embodiment 3, therefore, only the differences from Embodiment 1 will be described, and explanations for other parts will be omitted as appropriate.

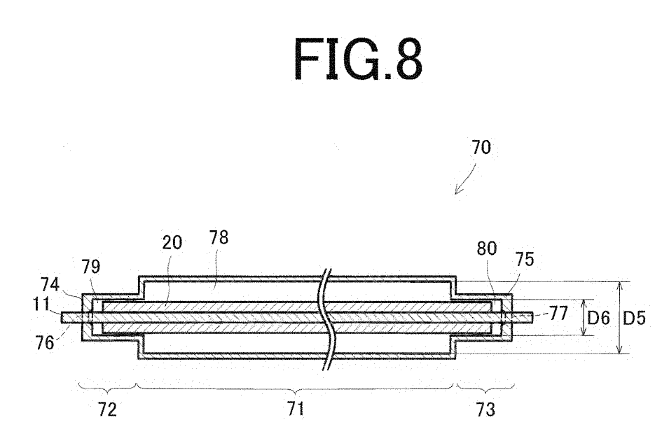

FIG. 8 is a schematic view of a foaming restriction member according to Embodiment 3. In the present embodiment, a foaming member 70 as shown in FIG. 8 is used as the foaming restriction member different from the foaming restriction member (flange 30) of Embodiment 1. The foaming member 70 is composed of a foaming section 71 having a large inner diameter D5, and foaming restriction sections 72, 73 having a smaller inner diameter D6 than the inner diameter D5. At the opposite ends 74, 75 of the foaming restriction sections 72, 73, insertion portions 76, 77 for inserting therethrough the ends of the core body 11 are formed, as in the flange 30. Inside the foaming section 71 and the foaming restriction sections 72, 73, hollow portions 78, 79, 80 for holding the foamable material 20 (see FIGS. 3A to 3C) extruded onto the core body 11 in the shaping step (a) are provided concavely. The hollow portions 78, 79, 80 are spaces continuously provided in a concave form within the foaming member 70, and the width in the diametrical direction of the hollow portion 78 (inner diameter D5 of the foaming member 70) and the width in the diametrical direction of the hollow portions 79, 80 (inner diameter D6 of the foaming member 70) are different from each other.

Next, a method for forming the elastic layer 12 (see FIG. 2) with the use of the foaming member 70 will be described. The elastic layer 12 is formed by the shaping step (a), the foaming step (b), and the polishing step (c) (see FIGS. 3A to 3C) in the same manner as in Embodiment 1. In the foaming step (b), the above foaming member 70 is used, and the foamable material 20 extruded onto the core body 11 in the shaping step (a) is foamed, with the foaming member 70 being mounted on the extruded foamable material 20, to obtain the foamed elastic material 23. That is, the portion of the foamed elastic material 23 mounted with the foaming section 71 is finally turned into the free portion 15 of the elastic layer 12 as a consequence of the free foaming of the foamable material 20 in the hollow portion 78 having the larger inner diameter D5. On the other hand, the portions of the foamed elastic material 23 mounted with the foaming restriction sections 72, 73 are finally turned into the grip portions 13, 14 of the elastic layer 12 at the foaming ratio restricted as a consequence of the moderate restriction of the foaming of the foamable material 20 in the hollow portions 79, 80 having the smaller inner diameter D6 than the inner diameter D5. After the foaming step (b), the foamed elastic material 23 is polished in the polishing step (c) to form the elastic layer 12 (see FIG. 3C), in the same manner as in Embodiment 1.

In the press roll 10 (see FIG. 2) prepared using the foaming member 70, as in Embodiment 1, the difference between the specific gravity in the neighborhood of the leading ends of the grip portions 13, 14 and the specific gravity of the free portion 15 of the elastic layer 12 is 0.02 or more; when the specific gravity of the free portion 15 is 0.7 or less, the proportion of the difference between the specific gravity in the neighborhood of the axially opposite leading ends of the grip portions 13, 14 and the specific gravity of the free portion 15 to the specific gravity of the free portion 15 is 10% or more, but 70% or less; and further the difference between the hardness in the neighborhood of the leading ends of the grip portions 13, 14 and the hardness of the free portion 15 is 3° or more, but 10° or less. Hence, when the press roll 10 is applied to the fixing device 1 (see FIG. 5), as in Embodiment 1, the grip force for driving the heat generating sleeve 40 (belt-shaped) can be enhanced, and the surface pressure during toner fixation can be ensured.

In the present embodiment, the foaming of the foamable material 20 in the hollow portion 78 of the foaming member 70 is set to be free foaming. However, the specific gravity and hardness distributions of the free portion 15, as well as those of the grip portions 13, 14 of the elastic layer 12, can be easily controlled by changing, as appropriate, the inner diameter D5 of the hollow portion 78. Hence, the use of the foaming member 70 of the present embodiment enables the specific gravity and hardness distributions of the press roll to be freely controlled in comparison with Embodiment 2.

### Modifications of Fixing Member

Some embodiments of the present invention have been described above, but it is to be understood that the basic configuration of the present invention is in no way limited to these embodiments. The fixing member according to the present invention is not limited to the ones obtained by the above-mentioned foaming restriction members, if the difference in specific gravity between the grip portion and the free portion of the elastic layer can be settled within the above predetermined ranges. That is, with the present invention, it matters that the foaming ratio of the predetermined location of the elastic layer can be restricted to a predetermined value by use of the foaming restriction member, and it is advisable to change the shape or the like of the foaming restriction member as required.

The fixing member according to the present invention is used preferably as the above-mentioned press roll, but can also be used as a fixing roll or the like. As described here, the usage mode of the fixing member according to the present invention is not particularly limited.

A fixing device equipped with the fixing member according to the present invention can be installed on various image forming apparatuses (particularly of an electrophotographic mode) such as a copier, a facsimile, a laser beam printer, other printers, and compound machines as combinations of them. Further, the heating means in the fixing device is not limited to the electromagnetic induction heating device and, for example, a halogen heater, an electrothermal wire heater, an infrared heater, a carbon heater, or microwave may be used.

The fixing member according to the present invention can be applied to a transport member of a transport device (transport unit) for transporting a recording medium such as paper. Examples of the transport member include paper sending rolls such as a paper feed roll and a paper supply roll.

### EXAMPLES

The present invention will be described more concretely by way of Examples, but is in no way limited to these Examples.

### Example 1

In Example 1, a vulcanizing agent, a catalyst, a foaming agent, and a coloring agent were blended with Si rubber (X-30-4037U, produced by Shin-Etsu Chemical Co., Ltd.), and they were kneaded using a milling roller to obtain an Si rubber material. Separately, a core metal coated with a primer was provided after dryness. Then, the Si rubber material was extruded onto the outer peripheral surface of the core metal by use of an extruder to form a roll having an outer diameter of 30.4 mm. A flange (see FIG. 4) having an inner diameter of 34.0 mm was mounted on each of opposite end portions of the extruded roll, and the roll was foamed and cured. Then, the surface of the roll after foaming and curing was polished with a cylindrical polishing machine to obtain a roll A of an inverse crown shape having a smaller outer diameter in a middle portion than in end portions thereof. The foaming ratio of the resulting roll A was measured. The foaming ratio of the portion not mounted with the flange (i.e., free portion) was 2.15, whereas the foaming ratio of the portions mounted with the flanges (i.e., grip portions) was 1.48. Then, the surface of the roll A was coated with an adhesive, and covered with a fluororesin tube having a film thickness of 30 μm to obtain a roll B.

### Comparative Example 1

In Comparative Example 1, rolls were obtained in the same manner as in Example 1, except that foaming and curing were performed without using the flange of Example 1. The roll obtained by polishing the surface of the roll after foaming and curing was designated as “roll C”, and the roll obtained by covering the roll C with the fluororesin tube was designated as “roll D”.

### Measurement of Outer Diameter

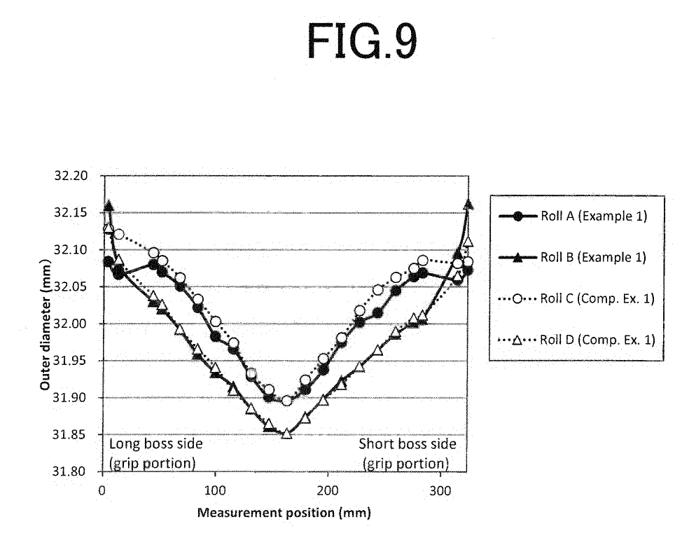

Using a laser length measuring machine (RSV15100-3C, manufactured by Tokyo Opto-Electronics Co., Ltd.), the outer diameters of the rolls A, B obtained in Example 1 and the rolls C, D obtained in Comparative Example 1 were measured (21P rotational outer diameter measurement), and the results are shown in FIG. 9. These measurements were made at 21 measurement positions in a range from 3.8 mm to 323.2 mm in the longitudinal direction of each roll, the start point (measurement position: 0 mm) being one leading end of the core metal placed in bearings of the laser length measuring machine (long boss side: the side of the core metal longer in one axial direction), and the end point being the opposite leading end of the core metal (short boss side: the side of the core metal shorter in the opposite axial direction), with each roll being caused to make one rotation. Each outer diameter value in FIG. 9 is the average of the measured values obtained by rotating the roll through one revolution.

The results of the measurements confirmed that the outer diameters of the roll A and the roll C were nearly equal, as shown in FIG. 9. Similarly, the outer diameters of the roll B and the roll D were confirmed to be nearly equal.

### Measurement of Hardness

Using a rubber hardness meter (ASKER C, manufactured by KOBUNSHI KEIKI CO., LTD.), the hardnesses of the rolls A, B obtained in Example 1 and the rolls C, D obtained in Comparative Example 1 were measured, and the results are shown in Table 1. These measurements were made at a load of 9.8 N at measurement positions including 1 location (0°) in the circumferential direction and 5 locations in the longitudinal direction of each roll for the rolls A, C, and 4 locations (90° equal distribution) in the circumferential direction and 5 locations in the longitudinal direction of each roll for the rolls B, D.

### Measurement of Specific Gravity

Using an electronic densimeter (MD-200S, manufactured by TGK), the specific gravity of the roll A obtained in Example 1 was measured, and the results are shown in Table 1. The measurement was made at 5 measurement positions in the longitudinal direction of the roll.

TABLE 1

| | | | | Long boss | | | | Short boss |
|---|---|---|---|---|---|---|---|---|
| | | | | side | | | | side |
| | | Measurement | | (grip | Middle | | | (grip |
| | | position | | portion) | (free portion) | | | portion) |
| | | (long. direction) | | 15.0 mm | 85.0 mm | 163.5 mm | 242.0 mm | 312.0 mm |
| Roll A | hardness | measurement | 0° | 42.5 | 32.0 | 32.0 | 31.5 | 40.0 |
| (Ex. 1) | | position | | | | | | |
| | | (circum. | | | | | | |
| | | direction) | | | | | | |
| | specific gravity | | | 0.602 | 0.428 | 0.424 | 0.423 | 0.598 |
| Roll B | hardness | measurement | 0° | 53.5 | 48.0 | 47.5 | 47.5 | 52.5 |
| (Ex. 1) | | position | 90° | 53.5 | 47.5 | 47.5 | 47.5 | 52.5 |
| | | (circum. | 180° | 53.0 | 48.0 | 47.5 | 47.0 | 52.0 |
| | | direction) | | | | | | |
| | | | 270° | 53.5 | 48.0 | 48.0 | 47.5 | 52.5 |
| | average hardness | | | 53.4 | 47.9 | 47.6 | 47.4 | 52.4 |
| Roll C | hardness | measurement | 0° | 32.0 | 31.5 | 31.5 | 31.0 | 31.0 |
| (Comp. | | position | | | | | | |
| Ex. 1) | | (circum. | | | | | | |
| | | direction) | | | | | | |
| Roll D | hardness | measurement | 0° | 48.0 | 49.0 | 49.0 | 48.5 | 48.0 |
| (Comp. | | position | 90° | 47.5 | 48.5 | 49.0 | 48.5 | 47.5 |
| Ex. 1) | | (circum. | 180° | 48.0 | 48.5 | 48.5 | 49.0 | 47.5 |
| | | direction) | | | | | | |
| | | | 270° | 47.5 | 49.0 | 49.0 | 48.5 | 47.5 |

| | | | | | |
|---|---|---|---|---|---|
| average hardness | 47.8 | 48.8 | 48.9 | 48.6 | 47.6 |

long. direction: longitudinal direction
circum. direction: circumferential direction

The results of the measurements confirmed, as shown in Table 1, that the hardness and specific gravity of the roll A were both greater in the grip portion than in the free portion and, when the average specific gravity of the free portion was 0.425, the difference between the average specific gravity of both grip portions (0.600) and the average specific gravity of the free portion (0.425) was 0.175. It was confirmed, on the other hand, that the hardness of the roll C was not different between the free portion and both grip portions, but was nearly uniform. Moreover, the hardness of the roll B showed the same tendency as that of the hardness of the roll A, and the hardness of the roll D showed the same tendency as that of the hardness of the roll C. The specific gravity of the roll C was not measured, but like the hardness, is presumed not to be different between the free portion and both grip portions, but to be nearly uniform.

### Measurement of Surface Pressure

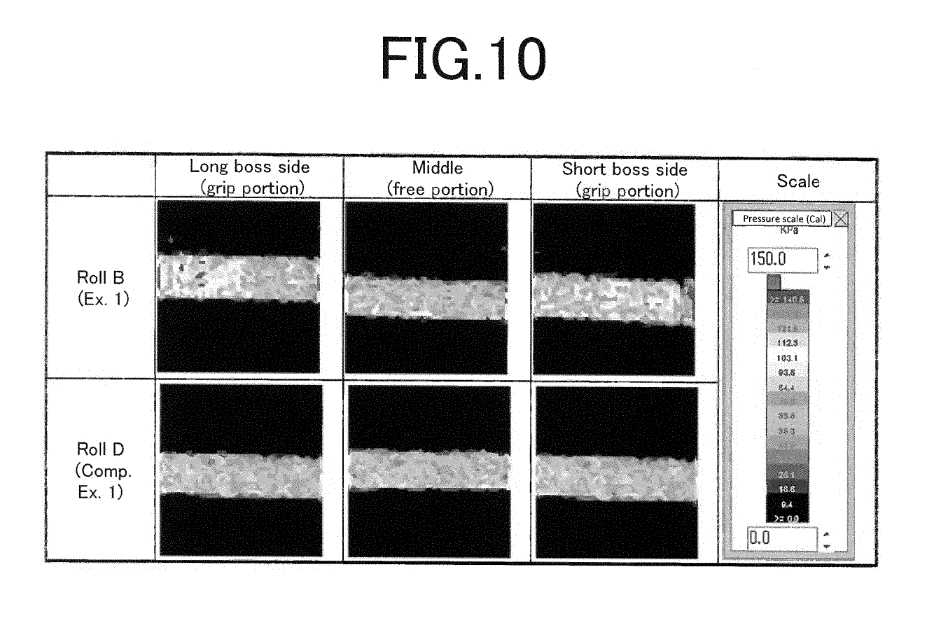

Using a simulator evaluator (manufactured in-house), the surface pressures of the roll B obtained in Example 1 and the roll D obtained in Comparative Example 1 were measured, and the results are shown in FIG. 10. These measurements were made by setting each roll in the simulator evaluator, interposing a pressure measuring sensor (I-SCAN, manufactured by Nitta Corporation) between each roll and the metal roll of the simulator evaluator, and measuring the surface pressure at 3 measurement positions in the longitudinal direction. As measurement conditions, compressibility when each roll was pressed against the metal roll was taken as 25% (the rubber wall thickness of each roll was decreased by 25% upon flattening).

The results of the measurements confirmed that the surface pressure of the roll B was higher in both grip portions than in the free portion even under the operating environment of an image forming apparatus, whereas the surface pressure of the roll D was not different between the free portion and both grip portions, but was nearly uniform, as shown in FIG. 10.

### SUMMARY

The above results demonstrated that in the press roll (fixing member) having the elastic layer (foamed silicone rubber) formed using the flange (foaming restriction member), when the specific gravity of the free portion of the elastic layer was 0.7 or less, the difference between the specific gravity of both grip portions and the specific gravity of the free portion was 0.02 or more. It also became clear that even under the operating environment of the image forming apparatus, the surface pressure of the opposite end portions (both grip portions) of the press roll was kept at a predetermined value or higher. In the above Examples, the elastic layer composed of silicone rubber was used. However, even when a material formable into an elastic layer, such as fluororubber or urethane rubber, is used, comparable results are expected to emerge.

Hence, the press roll prepared using the flange can ensure the surface pressure necessary for toner fixation, and can achieve both of the enhanced grip force of the elastic layer and cost efficiency.

### INDUSTRIAL APPLICABILITY

The fixing member according to the present invention is preferably used, particularly, in a fixing unit of an image forming apparatus such as an electrophotographic copier or printer.

### EXPLANATIONS OF LETTERS OR NUMERALS

1 Fixing device
10, 60, 100 Press roll
11, 101 Core body
12, 61, 102 Elastic layer
13, 14, 62, 63, 106, 107 Grip portion
15, 64 Free portion
20 Foamable material
21, 22, 24, 25, 74, 75 End portion
23 Foamed elastic material
30 Flange
31, 51 Upper surface
32, 52, 76, 77 Insertion portion
33, 53 Bottom surface
34, 54 Opening
35, 55 Mounting portion
40 Heat generating sleeve
41 Electromagnetic induction heating device
42 Magnetic field absorption member
43 Fixing roll
44 Coil guide
45 Unfixed toner image
46 Recording medium
47 Excitation coil
48 Core
50 Tapered flange
56, 57 Side wall
70 Foaming member
71 Foaming section
72, 73 Foaming restriction section
78, 79, 80 Hollow portion
103 Mold release layer
104 Foamed silicone rubber layer
105 Fluororesin tube

1. A fixing member having an elastic layer of a foamed elastic material on an outer peripheral surface of a core body, wherein
the elastic layer is an integrally shaped product of the foamed elastic material, and
when a specific gravity of the foamed elastic material in axially opposite end portions of the elastic layer is designated as d₁, a specific gravity of the foamed elastic material in a portion of the elastic layer other than the axially opposite end portions is designated as d₂, and the specific gravity d₂ is 0.7 or less, a proportion of a difference between the specific gravity d₁ and the specific gravity d₂ to the specific gravity d₂ is 10% or more, but 70% or less.

2. The fixing member according to claim 1, wherein
a mold release layer composed of a fluororesin tube is provided on an outer peripheral surface of the portion of the elastic layer other than the axially opposite end portions.

3. A method for producing a fixing member having an elastic layer of a foamed elastic material on an outer peripheral surface of a core body, comprising:
a shaping step of extruding a foamable material onto the outer peripheral surface of the core body;
a foaming step of foaming the foamable material, which has been extruded in the shaping step, while restricting foaming of opposite end portions of the extruded foamable material as compared with a portion thereof other than the opposite end portions, to obtain the foamed elastic material; and
a polishing step of polishing the foamed elastic material obtained in the foaming step, thereby forming the elastic layer,
wherein the elastic layer is an integrally shaped product of the foamed elastic material, and
when a specific gravity of the foamed elastic material in axially opposite end portions of the elastic layer is designated as d₁, a specific gravity of the foamed elastic material in a portion of the elastic layer other than the axially opposite end portions is designated as d₂, and the specific gravity d₂ is 0.7 or less, a proportion of a difference between the specific gravity d₁ and the specific gravity d₂ to the specific gravity d₂ is 10% or more, but 70% or less.

4. The method for producing a fixing member according to claim 3, wherein
in the foaming step, the foamable material extruded in the shaping step is foamed, with a foaming restriction member being mounted on each of the opposite end portions of the foamable material.

5. The method for producing a fixing member according to claim 3, wherein
in the foaming step, the foamable material extruded in the shaping step is foamed, with a foaming restriction member being mounted on the foamable material.
